(19) United States
(12) Patent Application Publication
(10) Pub. No.: US 2010/0047399 A1
(43) Pub. Date: Feb. 25, 2010

(54) Consumable Porous Food Product Covered with a Non-Porous Coating

(76) Inventor: John J. Philbin, Chicago, IL (US)

Correspondence Address: BISHOP & DIEHL, LTD., 1320 TOWER ROAD, SCHAUMBURG, IL, 60173, US

(21) Appl. No.: 12/543,464

(22) Filed: Aug. 18, 2009

Related U.S. Application Data
(60) Provisional application No. 61/189,538, filed on Aug. 20, 2008.

(51) Int. Cl. A23P 1/00; A23L 1/48; A23P 1/08; A23L 1/22

(52) U.S. Cl. 426/85; 426/302; 426/305; 426/390

(57) ABSTRACT

A consumable liquid is orally drawn into a food product and absorbed by an internal structure of the product, before the product is consumed. The product includes a substantially non-porous coating covering its outer surface. In one embodiment, a channel with a porous filling therein provides fluid communication so that when one opening is immersed in a liquid and a reduced pressure is orally applied to the other opening, the liquid is drawn into the filling and absorbed by the internal structure.

### CROSS-REFERENCE TO RELATED APPLICATIONS

This utility patent application claims the benefit of U.S. Provisional Patent Application Ser. No. 61/189,538, filed on Aug. 20, 2008, the disclosure of which is incorporated herein, by reference.

### TECHNICAL FIELD

The present invention pertains generally to edible food products that absorb a liquid, and more specifically, to a consumable, liquid-absorbent food product covered with a non-porous-coating so that a liquid drawn into the interior of the food product is absorbed.

### BACKGROUND OF THE INVENTION

For many people, eating appetizing food is an enjoyable experience. Moreover, mixing different kinds of foods together can enhance the experience. For instance, it is well known that dipping a food product into a consumable liquid or beverage will not only soften the food product, but also combine the flavor of the beverage with the food product. Specifically, if a cookie is dipped in a liquid such as milk, the milk will be absorbed into and soften the cookie to make it taste better. Likewise, if a doughnut is dipped into a liquid, such as coffee, the coffee will soften the doughnut and enhanced the doughnut's flavor. However, the dipping of a food product into a consumable liquid can sometimes be messy since the liquid frequently drips from the food product onto the table or onto the person before the food product is consumed.

### SUMMARY OF THE INVENTION

A food product is provided that enables a consumable liquid to be orally drawn in and absorbed by the product for consumption. In an embodiment, the food product includes a wafer or cookie having an outer surface and an elongated channel provided therein. A coating is provided on the outer surface of the cookie and a filling occupies the elongated channel.

Other embodiments, features, and advantages of the present invention will be, or will become, apparent to one having ordinary skill in the art upon examination of the following drawings and detailed description. It is intended that all such additional systems, methods, features, and advantages included within this description be within the scope of the present invention, and can be protected by the accompanying claims or others.

### BRIEF DESCRIPTION OF THE DRAWINGS

The invention may be better understood with reference to the following drawings. The components in the drawings are not necessarily to scale, emphasis instead being placed upon illustrating the principles of the invention. In the drawings, like reference numbers designate corresponding parts throughout.

FIG. 1 is a plan view of a food product in accordance with the present invention;

FIG. 2 is an elevation cross-sectional view of the food product of FIG. 1 taken along plane 2-2;

FIG. 3 is a plan view of the food product of FIG. 1 after the ends of the product have been bitten off by a user; and,

FIG. 4 schematically illustrates a longitudinal cross-section of the food product of FIG. 3 in use for orally drawing a consumable liquid into the interior of the food product wherein the liquid is absorbed.

### DETAILED DESCRIPTION

The following descriptions of detailed embodiments are for exemplifying the principles and advantages of the inventions claimed herein. They are not to be taken in any way as limitations on the scope of the inventions.

The present invention is usable to orally draw a consumable liquid into the interior of a consumable food product, wherein the liquid is absorbed by the material comprising the interior, so that the food product can then be consumed. As a result, the taste of the food product is combined with that of the liquid, and the texture of the food product is softened by the liquid. The food product is also fun to use since a user may immerse an open portion (free of a coating) of the consumable food product into a consumable liquid, orally apply sufficient suction to another open portion of the food product, and draw the consumable liquid into the interior of the food product. Because at least a portion of the interior is either relatively porous or includes open cells, the liquid is readily absorbed, and the reduced atmospheric pressure applied orally at one opening, by sucking, is communicated to another opening that is immersed in the liquid, so that the liquid is fully drawn into the interior portion. The coating or covering seals the rest of the food product so that air is not drawn through the surface above the liquid, which would prevent the liquid from being drawn into the interior.

Once the interior structure of the food product is relatively saturated with the liquid, the user consumes the food product, whose flavor is enhanced by the consumable liquid that has been absorbed into its interior.

As noted above, at least a portion of the interior of the food product must be sufficiently porous so that a reduced atmospheric pressure orally applied at one point on the surface of the food product can draw a liquid into another point that is immersed in the liquid, and the porosity should be sufficient to absorb a desired quantity of the consumable liquid when the liquid is thus drawn into the interior of the food product. In an embodiment, the food product may be completely sealed by an outer coating such that the user needs to remove the coating from two points that are spaced-apart on the outer surface of the food product before submerging one point in the consumable liquid. The coating can be removed from the two points by, for example, biting or cutting the ends of the food product. In an alternative embodiment, the two points that are spaced-apart on the outer surface of the food product are already free of the coating, such that the user does not need to create these two openings before using the food product.

In an embodiment, the interior of the food product can include a porous honey graham or vanilla flavored sweetened dough that is baked and surrounds a filling. The interior structure is covered with a chocolate, yogurt, or sugar coating that complements the porous, sweetened interior. For instance, one combination can be a chocolate outer coating on the outside of a honey graham sweetened cracker surrounding a filling. Another combination can be a yogurt outer coating on a porous vanilla flavored cookie surrounding a filling. Of course, various combinations of these and other coatings and internal structures can be made, depending on the user's tastes.

One portion of this food product that provides an opening to the interior structure can then be dipped in a beverage, such as coffee, cocoa, or milk. When the user applies oral suction to the other portion that provides an opening, the beverage is drawn up into the interior porous structure of the food product and absorbed. The user may then consume the food product, which can serve as a dessert or as a snack.

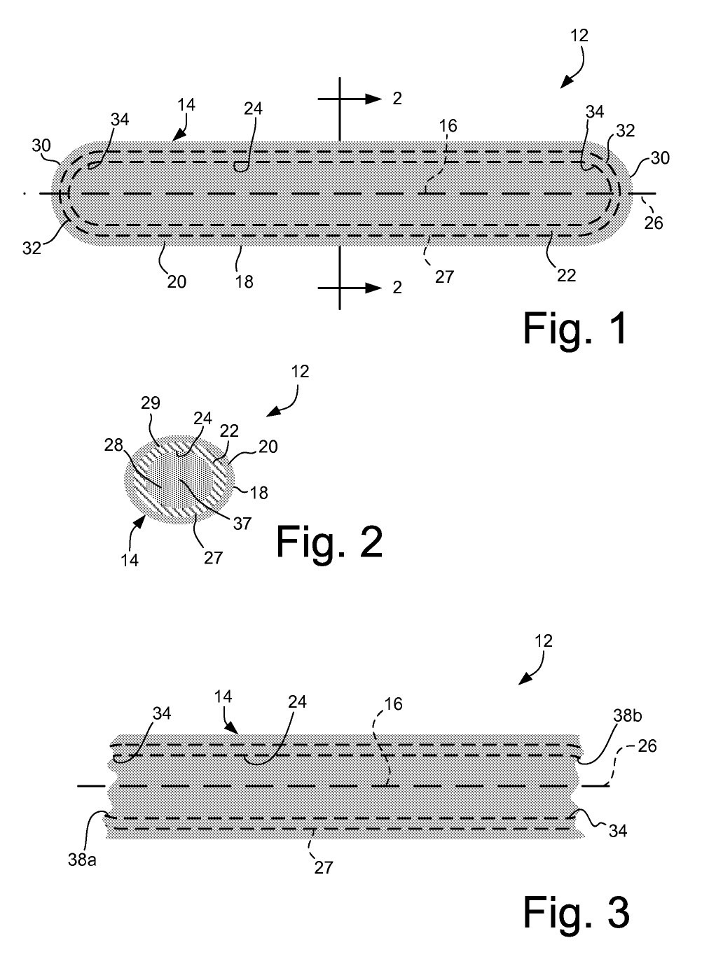

FIG. 1 depicts a plan view of a food product in accordance with the present invention. Preferably, but not necessarily, the product 12 is an edible elongated biscuit 14 having a longitudinal axis 16 and a pair of terminal ends 30. The outside 18 of the biscuit 14 comprises a non-porous material 20 such as chocolate or a conventional chocolate favored edible compound. In an embodiment, the biscuit is about three (3) to four (4) inches in length.

FIG. 2 illustrates a cross-sectional view of the food product 12 taken along plane 2-2 of FIG. 1. Preferably, but not necessarily, the biscuit 14 is generally oval or circular in cross-section. However, in an alternative embodiment, the biscuit 14 can be generally square, rectangular, polygonal, or the like.

The biscuit 14 includes a crisp cookie or wafer 22. Preferably, but not necessarily, the wafer 22 is generally tubular to provide a longitudinal cylinder or passage 24 therein. Accordingly, the longitudinal axis 26 (FIG. 1) of the wafer 22 is in coaxial alignment with the longitudinal axis 16 (FIG. 1) of the biscuit 14.

The wafer 22 can be of unitary construction or constructed of one or more pieces of wafer. Moreover, in manufacture, the wafer 22 can be made of material that is extruded, spirally wrapped, rolled, or the like.

As previously indicated, the outer surface 27 of the wafer 22 is completely enveloped or covered with a non-porous material 20. Also, the ends 32 (FIG. 1) of the wafer 22 are enveloped or covered with the non-porous material 20. Accordingly, the wafer 22 is not visible from the outside of the biscuit 14. In an embodiment, but not necessarily, the wafer 22 can be coated by an enrobing machine.

Within the longitudinal passage 24 of the wafer 22 is a filling 28 of porous material. In an embodiment, the filling 28 is generally obround or cylindrical, and thus oval or circular in cross-section, with the longitudinal axis 37 of the filling being in coaxial alignment with the longitudinal axis 26 of the wafer 22. Preferably, the filling 28 is porous enough wherein, as described in detail further herein, a liquid can be drawn into the filling at one end 34 of the passage 24 when suction is applied to the other end 34 of the passage. Desirably, but not necessarily, the ends 34 of the passage 24 are closed or sealed by the wafer 22 and/or the nonporous material 20 on the outside of the biscuit 14. In either case, it is desired that the filling not be visible from the outside of the biscuit.

Turning back to FIG. 1, it is desired that a user remove the ends 30 of the product 12 to expose the filling 28 within the passage 24. This can be accomplished by the user biting off the ends 30 so that the product generally has the configuration depicted in FIG. 2. Accordingly, the removed ends 30 can be consumed by the user.

With the ends removed, the passage 24 and the porous filling 28 therein enables a user to orally apply suction at one end to draw a consumable liquid into the opposite end, so that the consumable liquid is absorbed into both the filling 28 and, to a lesser extent, the wafer 22 of the food product 12. Internal channel or passage 24 couples orifice 38a and orifice 38b in fluid communication with each other. When the consumable liquid is drawn into the internal channel the porous interior material or filling 28 is exposed to the consumable liquid, which is readily absorbed into the porous interior material. Porous interior material 28 can alternatively comprise interstitial spaces, or can be open cell, or can comprise dehydrated material that readily absorbs a liquid.

The food product in accordance with the present invention can be of any shape or size that is practical to handle and use with a consumable liquid, so that the liquid is drawn into the food product and absorbed therein. Therefore, the food product can be elongated, square-shaped, circular-shaped or any other suitable shape.

Depending on the ingredients of the filling 28 and the wafer 22, the absorption rate of the liquid will vary. However, the absorption rate should be sufficient so that the interior material is flavored within a reasonable time after submerging one orifice of the food product in the liquid and orally applying suction to the other orifice.

Furthermore, coating 20 must substantially seal the porous filling 28 and wafer 22 (i.e., the interior material), to prevent air from freely being drawn into the interior material when an oral suction is applied by the user, which would interfere with the consumable liquid being drawn into the interior of the food product and absorbed. In addition, the coating seals the liquid absorbed in the food product, so that to the liquid generally does not drip from the food product as the food product is consumed after the liquid is absorbed therein.

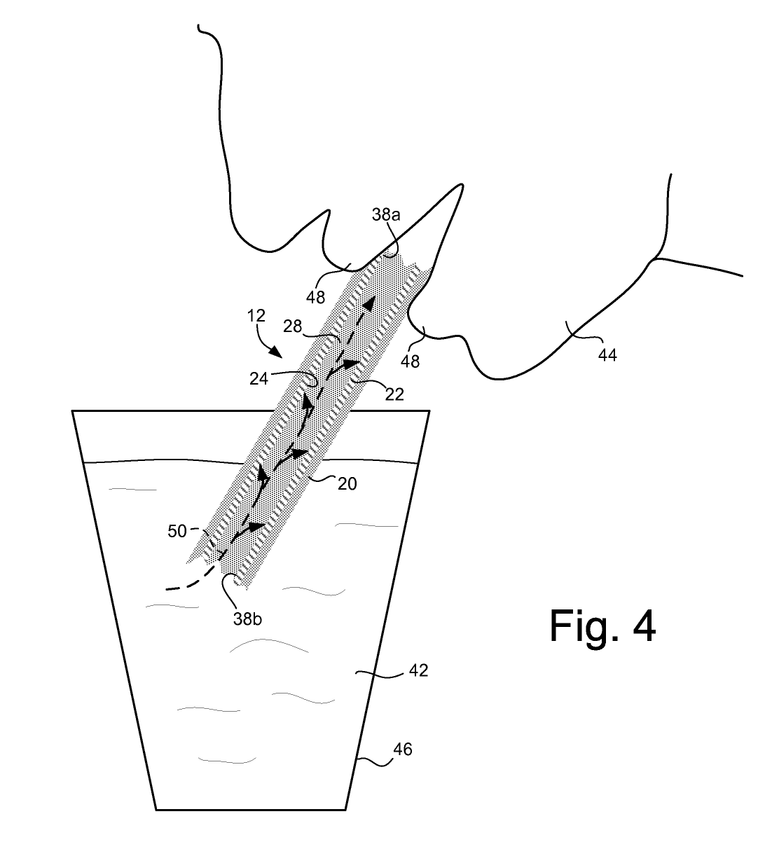

FIG. 4 schematically illustrates how a consumable food product 12 in accordance with the present invention is used to orally draw a consumable liquid 42 into the interior of the food product. A user 44 has partially submerged food product 12 in consumable liquid 42, which is held in a container 46. Lips 48 of user 44 are sealed around food product so that the user can orally apply suction to food product 44 at an orifice 38a. Consumable liquid 42 is drawn into the food product through a second orifice 38b disposed at the opposite end absorbed by the porous interior material comprising filling 28 and wafer 22.

Container 46 may be a glass, as shown in the example of FIG. 4, or a coffee cup, bowl, or any other vessel that can hold a consumable liquid and provide sufficient depth to partially submerge food product 12 within the consumable liquid.

Consumable liquid 42 may be any consumable liquid that has a viscosity sufficiently low so that it can be drawn into food product 12 through the fluid communication provided between the spaced-apart openings. Fluid communication is established because the openings 38a,38b provide access to the porous interior material wherein one opening 38a can be submerged into a liquid, and when suction is orally applied to the other opening 38b, the liquid is drawn into and absorbed into the interior porous material. Consumable liquid 42 may be a beverage, a soup, or a sauce. Those skilled in the art will recognize that many other liquids could be used for the consumable liquid, including but not limited to, soft drinks, coffee, milk, milkshakes, juices, tea, beer, wine, and liquor. The present invention can be used with any of these liquids, regardless of their ingredients, so long as the liquids are of sufficiently low viscosity, as explained above.

When user 44 orally applies sufficient suction to orifice 38a of the food product, consumable liquid 42 is drawn into the interior of the food product by way of a central channel 24 that provides fluid communication to convey the consumable liquid along the center of the food product from the submerged portion of food product 12, through orifice 38b. The central channel extends longitudinally from the submerged orifice, through the food product, to orifice 38a.

Dash line arrow 50 indicates the path along which consumable liquid 42 flows into central channel 24. The liquid readily penetrates the walls of central channel 24 and is absorbed by a porous interior material comprising wafer 22

As indicated previously, the outer surface of wafer 22 is covered with coating 20 (except over user created openings 38a and 38b) so that air does not freely pass through the outer surface of the wafer, which would substantially reduce the suction that is orally applied and possibly prevent liquid from being fully drawn up into central channel 24. In addition, coating 20 helps to retain the consumable liquid absorbed within the wafer 24, as the food product is being consumed. The wafer 22 and filling 28 is relatively dry and free of moisture before use.

Coating 20 may be any substantially non-porous edible food component, such as chocolate, sugar, yogurt, fractionated palm kernel oil and butter, hardened gelatin, marzipan, glaze, icing, sugar glaze, or candy that is applied to the outer surface of the wafer 22. The non-porous coating can be made of any number of edible ingredients as long as the coating resists dissolving and melting away too quickly when the food product is immersed in consumable liquid 42—at least for a reasonable time after the liquid is absorbed by the interior material (i.e., filling 28 and wafer 22). Also, for at least the time that coating is immersed in the liquid, the coating should not melt. Thus, when user 44 submerges consumable food product 12 in consumable liquid 42, coating 20 must not dissolve immediately or melt away too quickly. The thickness of the coating necessary to prevent its ready dissolution upon submersion in a liquid will vary depending upon the selected coating ingredients, the nature of the liquid, and the temperature of the liquid. In an embodiment, but not necessarily, the melting point temperature of the inside filling 28 is less than the melting point temperature of the outside coating 20. In an alternative embodiment, the melting point temperature of the inside filling 28 is greater than the melting point temperature of the outside coating 20.

Depending on the absorptive characteristics of the interior structure of food product 12, it is possible that as consumable liquid 42 is drawn into the food product and absorbed as shown by the general path indicated by dotted line arrows 50, that some consumable liquid 42 may exit through opening 38a. Even if user 44 imbibes some of consumable liquid 42, the intended function of the food product is not to server as a straw to draw the consumable liquid 42 into the user's mouth, but instead, to draw the liquid into the interior of the food product so that the liquid is absorbed into porous interior material 28 and 22, thereby enhancing the flavor and texture of food product 12 when the food product is subsequently consumed.

Furthermore, it is likely that a coating will be selected that provides a desired food flavoring appropriate to the liquid being absorbed by the food product. For example, yogurt, chocolate, marzipan, or a sugary glaze or icing may be selected to coat a sweet food product. Of course, those skilled in the art will also note that more than one coating may be selected and applied to the food product. For example, a chocolate coating that seals the porous interior material of a sweet food product may then be covered with an outer layer comprising a vanilla-flavored coating.

Instead of the filling 28 being porous material, the filling material used in the food product may be formed to have open cells or interstitial spaces. For instance, the filling material may comprise, for example, chocolate chips, nuts, or other matter that does not itself absorb liquid. However, the wafer and the interstitial spaces between the filling material readily hold a consumable liquid due to capillary forces, so that the liquid is effectively absorbed by the internal material of the food product.

It should be emphasized that the above-described embodiments of the present invention, particularly, any “preferred” embodiments, are possible examples of implementations merely set forth for a clear understanding of the principles for the invention. Many variations and modifications may be made to the above-described embodiment(s) of the invention without substantially departing from the spirit and principles of the invention. All such modifications are intended to be included herein within the scope of this disclosure and the present invention.

What is claimed is:

1. A consumable food product adapted to enable a consumable liquid to be orally drawn into the food product and absorbed, comprising:
(a) consumable structural means for providing fluid communication between two spaced-apart points on a surface of the food product and for absorbing a consumable liquid that is drawn into the consumable structural means through one of the spaced-apart points when a partial vacuum is orally applied to the other of the spaced-apart points;
(b) coating means that is consumable, for substantially sealing the surface of the consumable structural means, to substantially prevent free entry of air therein, except where the spaced-apart points are disposed; and,
(c) a filling surrounded by the consumable structural means.

2. A consumable food product adapted to enable a consumable liquid to be orally drawn into the food product and absorbed, comprising:
(a) an interior liquid-absorptive material that is consumable and which is formed so as to provide fluid communication between two spaced-apart points on a surface of the material; and
(b) a coating that is consumable and is applied to an outer surface of the interior liquid-absorptive material to substantially seal the liquid-absorptive material so as to substantially prevent free entry of air into the interior liquid-absorptive material, said consumable product thereby being adapted to enable a person to orally apply a reduced atmospheric pressure to one of the two spaced-apart points while the other of the two spaced-apart points is immersed in a consumable liquid, so that a consumable liquid is drawn into and absorbed by the interior liquid-absorptive material; and,
(c) a filling surrounded by the interior liquid-absorptive material.

3. The food product of claim 2, wherein the two spaced-apart points are not sealed by the coating, so that the outer surface of the interior liquid-absorptive material is accessible to fluid communication with a consumable liquid and the reduced atmospheric pressure at the two spaced-apart points.

4. The food product of claim 2, wherein the two spaced-apart points are sealed by the coating, which is removable by a person at the two spaced-apart points to provide fluid communication with a humanly consumable liquid and the reduced atmospheric pressure.

5. The food product of claim 2, wherein the coating melts, after about 15 seconds, when the coating is submerged in the humanly consumable liquid.

6. The food product of claim 5, wherein the humanly consumable liquid is hot coffee.

7. The food product of claim 2, wherein the interior liquid-absorptive material includes a channel formed between the two spaced-apart points so that a consumable liquid drawn into the channel is exposed to the material and is thereby absorbed into the material.

8. A method for producing a consumable food product, wherein the consumable food product enables a consumable liquid to be orally drawn into and absorbed by the food product, comprising the steps of:
(a) producing an internal structure that is consumable and formed so as to provide fluid communication between two spaced-apart points on a surface of the structure; and
(b) substantially sealing an outer surface of the structure with a layer that is consumable, to substantially prevent free entry of air into the structure, to enable a person to orally apply a reduced atmospheric pressure to one of the two spaced-apart points while the other of the two spaced-apart points is immersed in a consumable liquid, so that a consumable liquid is drawn into and absorbed by the structure.

9. A method for creating a consumable food product that enables a consumable liquid to be orally drawn into and absorbed by the food product, comprising the steps of:
(a) producing a liquid-absorptive material that is consumable and formed so as to provide fluid communication between two spaced-apart points on a surface of the material; and
(b) sealing an outer surface of the liquid-absorptive material with a coating that is consumable, to substantially prevent free entry of air into the liquid-absorptive material, to enable a person to orally apply a reduced atmospheric pressure to one of the two spaced-apart points while the other of the two spaced-apart points is immersed in a consumable liquid, so that a consumable liquid is drawn into and absorbed by the interior liquid-absorptive material.

10. The method of claim 9, further comprising the step of forming a channel coupling the two spaced-apart points in fluid communication within the interior liquid-absorptive material.

11. The method of claim 9, wherein the interior liquid-absorptive material includes a plurality of open cells that are in fluid communication with each other.

12. The method of claim 9, wherein the step of sealing further comprises the step of preventing the coating from sealing the two spaced-apart points, so that the outer surface of the interior liquid-absorptive material is accessible to fluid communication with a consumable liquid and the reduced atmospheric pressure at the two spaced-apart points.

13. The method of claim 9, further comprising the step removing the coating covering the two spaced-apart points, so that the outer surface of the interior liquid-absorptive material is accessible to fluid communication with a consumable liquid and the reduced atmospheric pressure at the two spaced-apart points.

14. The method of claim 9, wherein the coating is characterized by melting, after about 15 seconds, when the coating is submerged in a humanly consumable hot liquid such as coffee.

15. The method of claim 9, wherein an exterior of the coating is characterized by becoming tacky during use.

16. A method for using a consumable food product that enables a consumable liquid to be orally drawn into and absorbed by the food product, comprising the steps of: (a) positioning the consumable food product so that one of two spaced-apart points on a surface of the consumable food product is immersed in a consumable liquid; and (b) orally applying a reduced atmospheric pressure to the other of the two spaced-apart points so that the consumable liquid is drawn into and absorbed by an interior material of the food product, without requiring that the consumable liquid be drawn into a user's mouth, so that the food product is enhanced by absorbing the consumable liquid.

17. The method of claim 16, wherein the consumable liquid is drawn into the user's mouth after being drawn into the interior material.

18. The method of claim 16, further comprising the step of consuming the food product after it has absorbed the consumable liquid.

19. The method of claim 16, further comprising the step of removing a coating covering the two spaced-apart points, so that an outer surface of the interior material is accessible to fluid communication with the consumable liquid and with the reduced atmospheric pressure at the two spaced-apart points.

20. The method of claim 16, wherein the consumable liquid has a viscosity sufficiently low so that a user is able to draw the consumable liquid into the interior material by orally applying the reduced atmospheric pressure.

21. The method of claim 16, wherein the consumable food product is used to absorb a beverage.
